(19) United States
(12) Patent Application Publication
(10) Pub. No.: US 2016/0204693 A1
(43) Pub. Date: Jul. 14, 2016

(54) TWO-STAGE CLOCKED ELECTRONIC EVERGY CONVERTER

(71) Applicant: OSRAM GmbH, München (DE)

(72) Inventors: Siegfried Mayer, Moosinning (DE); Olaf Busse, Munich (DE); Maximilian Gerber, Munich (DE); Horst Werni, Munich (DE)

(21) Appl. No.: 14/913,408

(22) PCT Filed: Aug. 11, 2014
(86) PCT No.: PCT/EP2014/067189

§ 371 Date: Feb. 22, 2016

(30) Foreign Application Priority Data
Aug. 23, 2013 (DE) 10 2013 216 878.0

(51) Int. Cl. H02M 1/42

(52) U.S. Cl. CPC H02M 1/4208

(57) ABSTRACT

A two-stage clocked electronic energy converter for transmitting an electrical power may include a first connection for connecting an electrical energy source, a second connection for connecting a load, and an intermediate circuit capacitor, wherein a first stage of the energy converter has a first converter in the boost operating mode, which first converter converts an electrical voltage at the first connection into an electrical intermediate circuit voltage at the intermediate circuit capacitor, and wherein the intermediate circuit capacitor supplies a second stage of the energy converter, which second stage supplies the load with electrical energy controllably in terms of the power, wherein a control unit sets the power drawn from the intermediate circuit capacitor by the second stage in such a way that an instantaneous minimum of the intermediate circuit voltage that is brought about by the drawing of power is greater than a predefined voltage comparison value.

### RELATED APPLICATIONS

The present application is a national stage entry according to 35 U.S.C. §371 of PCT application No.: PCT/EP2014/067189 filed on Aug. 11, 2014, which claims priority from German application No.: 10 2013 216 878.0 filed on Aug. 23, 2013, and is incorporated herein by reference in its entirety.

### TECHNICAL FIELD

Various embodiments relate to a two-stage clocked electronic energy converter for transmitting an electrical power, including a first connection for connecting an electrical energy source, a second connection for connecting a load, and an intermediate circuit capacitor, wherein a first stage of the two-stage clocked electronic energy converter has a first converter in the boost operating mode, which first converter converts an electrical voltage at the first connection into an electrical intermediate circuit voltage at the intermediate circuit capacitor, and wherein the intermediate circuit capacitor supplies a second stage of the two-stage clocked electronic energy converter, which second stage supplies the load with electrical energy controllably in terms of the power. Furthermore, the present disclosure relates to a lighting device including an illuminant and an electrical connection for connecting the lighting device to an electrical energy source. Finally, the present disclosure relates to a method for operating a two-stage clocked electronic energy converter, having an intermediate circuit capacitor, for transmitting an electrical power from an electrical energy source, connected to the energy converter, to a load, likewise connected to the energy converter, wherein a first stage of the two-stage clocked electronic energy converter uses a first converter in the boost operating mode, which first converter converts an input-side electrical voltage of the electrical energy source into an electrical intermediate circuit voltage at the intermediate circuit capacitor, which intermediate circuit capacitor supplies a second stage of the two-stage clocked electronic energy converter with electrical energy, which second stage supplies the load with electrical energy controllably in terms of the power.

### BACKGROUND

The present disclosure proceeds from an at least to-stage electronic ballast including a boost power factor control (PFC) stage at the input and an intermediate circuit electrolytic capacitor. In the case of electrolytic capacitors, besides the capacitance an important parameter is the equivalent series resistance (ESR), which encompasses losses of the electrolytic capacitor during intended operation such as ohmic conduction losses, dielectric polarity reversal losses and/or the like. The ESR can considerably impair the intended operation of the electrolytic capacitor.

The value of the ESR is very high particularly at low temperatures. This results in functional problems in the event of a cold start of the ballast. The prior art attempts to solve these problems with the aid of material usage. This is both costly with regard to the development of suitable ballasts and associated with additional costs and material outlay for the ballast.

### SUMMARY

Therefore, various embodiments provide for a given two-stage clocked electronic energy converter, operation even at low temperatures without having to intervene in the power-controlling components of the energy converter.

The present disclosure is based on the concept of using the ESR of the intermediate circuit capacitor in order to heat the intermediate circuit capacitor as rapidly as possible. For this purpose, ripple on the intermediate circuit voltage during intended operation is intended to be as high as possible, with the result that the ESR brings about a current flow which is as high as possible and which results in a corresponding thermal power. The ripple is a, generally high-frequency, voltage fluctuation of the intermediate circuit voltage and arises on the intermediate circuit voltage as a result of the clocked operation of the two stages of the energy converter. At the same time, the ripple should be limited with regard to its amplitude in such a way that undesired effects on parts or the totality of the energy converter are largely avoided. It should be taken into account, in particular, that the undershooting of a minimum intermediate circuit voltage can lead to the switching off of further components of the converter or loads connected thereto and/or a direct current flow from the energy source into the intermediate circuit capacitor can take place whilst avoiding the boost operating mode of the first stage.

For this purpose, in respect of the energy converter it is provided that a control unit is provided, which is designed to set the power drawn from the intermediate circuit capacitor by the second stage in such a way that an instantaneous minimum of the intermediate circuit voltage that is brought about by the drawing of power is greater than a predefined voltage comparison value. What can be achieved by a suitable choice of the predefined voltage comparison value is that impermissible undershooting of the intermediate circuit voltage can be avoided. The problems mentioned above can thus largely be avoided by a suitable choice of the voltage comparison value.

The power to be transmitted is generally the power which the energy converter draws from the energy source and provides for the load. The second stage of the energy converter can be formed by a buck converter, but also by a resonant converter, combinations thereof, a plurality of such circuits and/or the like. The intermediate circuit capacitor can be formed by an electronic capacitor, for example a film capacitor, a ceramic capacitor, but also in particular by an electrolytic capacitor. Precisely in the case or electrolytic capacitors that are used as intermediate circuit capacitors, the present disclosure proves to be particularly advantageous.

In order that the instantaneous minimum of the intermediate circuit voltage, generally essentially concomitantly determined by the ripple, can be influenced, the power drawn from the intermediate circuit capacitor by the second stage is settable, that is to say that only the power which is actually drawn from the intermediate circuit capacitor by means of the second stage is provided for the load. Accordingly, the second stage is controllable with regard to the drawn power preferably by means of the control unit. At the same time, the voltage comparison value can likewise be provided by means of the control unit. Furthermore, there is the possibility of the control unit also providing the comparison function of the comparison of the intermediate circuit voltage with the voltage comparison value and bringing about a corresponding control or regulation for the second stage of the energy converter. Furthermore, the control unit is preferably designed to monitor the intermediate circuit voltage for instantaneous minima, that is to say preferably to determine an individual minimum of the intermediate circuit voltage, in particular with regard to the voltage value. This can serve as a basis for the further control.

In a specific configuration in the case of an electronic ballast, a voltage swing at the intermediate circuit electrolytic capacitor can be detected by means of the microprocessor as control unit. The output current or the output power is then set depending on the detected voltage swing. As soon as the voltage swing is in a noncritical range, for example +/−50 V, this corresponding to a low ESR, the desired output power can be approached.

The present disclosure makes it possible to avoid the use of electrolytic capacitors having a high capacitance, which are significantly more expensive. Moreover, it is possible to use electrolytic capacitors having a high ESR at low temperatures. This may even be advantageous because as rapid heating as possible of the electrolytic capacitor can then be achieved.

Furthermore, the ESR generally increases as the electrolytic capacitor ages. By virtue of the present disclosure, therefore, end-of-life failures are largely reduced since it is possible to start with a lower current or a lower power. The quality of the electronic ballast thus increases. By way of example, under these circumstances, a longer lifetime can be guaranteed since it is no longer necessary to take account of such large tolerance windows in the calculation of the lifetime. Furthermore, it is possible to achieve a greater independence in the selection of electrolytic capacitors. One important advantageous aspect is that the use of an electronic ballast down to low temperatures of −30 to −40° C. can be made possible.

The present disclosure essentially uses a combination of two measures to achieve the advantages according to the present disclosure. One important aspect of the present disclosure is to limit the tapped power of the second stage 2 in such a way that the intermediate circuit voltage at the intermediate circuit capacitor, which is generally embodied as an electrolytic capacitor, does not assume any extreme values. Consequently, the power is limited in such a way that the minimum voltage of the intermediate circuit does fail below a specific predefined comparison value, that is to say is greater than the comparison value. An expedient value for the voltage comparison value is, for example, slightly below a minimum intermediate circuit voltage during intended operation. This makes it possible to prevent a maximum intermediate circuit voltage at the electrolytic capacitor from becoming too high.

In this disclosure, a “boost” stage is a stage of a generic two-stage clocked electronic energy converter which is operated in the boost operating mode. Accordingly, the term “boost” denotes a boost operating mode. “Buck” correspondingly denotes a buck operating mode.

Various embodiments provide for the voltage comparison value to be formed taking account of an instantaneous voltage comparison value determined depending on a temporally corresponding instantaneous value of the electrical voltage at the first connection, and the drawing of power to be set in such a way that the instantaneous minimum of the intermediate circuit voltage substantially reaches the instantaneous voltage comparison value. This configuration takes account of the fact that the input voltage at the first connection can be a non-constant voltage, in particular an AC voltage. In this case, it may be advantageous for the voltage comparison value to be embodied as an instantaneous voltage comparison value which can be tracked depending on the voltage instantaneously present at the first connection, in order in this way to further improve the inventive effect even in the case of non-constant voltages at the first connection. In particular, it can be provided that the instantaneous voltage comparison value corresponds to the voltage at the first connection or exceeds said voltage by a certain absolute value which can be determined, for example, by means of a factor and/or by means of a fixed supplementary value.

A further configuration of the present disclosure proposes that the second stage of the two-stage clocked electronic energy converter has a second converter in the buck operating mode or a resonant converter. Of course, a combination of a plurality of converters can also be connected to the intermediate circuit capacitor, which are preferably correspondingly controllable. As a result, the present disclosure can be applied very well to electronic ballasts from the prior art, such that the present disclosure also enables already existing electronic ballasts to be retrofitted.

In accordance with various embodiments, the intermediate circuit capacitor has a temperature sensor. The temperature sensor can be formed for example by a thermoelement, an NTC thermistor, an infrared measuring device or the like. Preferably, the temperature sensor is attached to a surface of the intermediate circuit capacitor or contacts the latter. Furthermore, the temperature sensor can, of course, also be integrated into the intermediate circuit capacitor. By way of example, the temperature sensor can be fixed to the intermediate circuit capacitor by means of adhesive bonding or clamping. This configuration makes it possible to use the temperature of the intermediate circuit capacitor for the control. In particular, it can be provided, of course, that the sequence according to the present disclosure is activated depending on the undershooting of a comparison temperature. What can be achieved in this way is that the sequence according to the present disclosure is activated only if it is necessary on account of the ambient conditions, in particular the ambient temperature.

If the ambient temperature is additionally also detected before the start of the electronic ballast, for example, the output current or the output power can be correspondingly preallocated in order that it is possible to ensure a reliable start by the electronic ballast.

The lighting device proposed by the present disclosure is characterized in that the lighting device has a two-stage clocked electronic energy converter according to the present disclosure, which supplies, as load, the illuminant with electrical energy controllably in terms of the power. As a result, the advantages and properties achieved with the energy converter according to the present disclosure can also be achieved with the lighting device. This proves to be advantageous precisely in the case of the lighting device since the reliability of intended operation can be significantly improved, particularly at low temperatures. The problems of electronic ballasts as known from the prior art, for example with regard to flicker, flashing or the like, can be considerably reduced, if not even completely avoided. Preferably, the connection of the lighting device is formed by the first connection of the energy converter. The illuminant as load can be connected to the second connection of the energy converter.

In respect of the method, various embodiments provide, in particular, for the power drawn from the intermediate circuit capacitor by the second stage to be set in such a way that an instantaneous minimum of the intermediate circuit voltage that is brought about by the drawing of the power exceeds a predefined voltage comparison value. That is to say that the instantaneous minimum of the intermediate circuit voltage does not fall below the voltage comparison value. The advantages and properties mentioned with regard to the device can be achieved as a result.

In accordance with various embodiments, it is proposed that an instantaneous voltage comparison value determined depending on a temporally corresponding instantaneous value of the electrical voltage at the first connection is used as the voltage comparison value, and the instantaneous minimum of the intermediate circuit voltage substantially reaches the instantaneous voltage comparison value. What is achieved as a result is that the intermediate circuit capacitor has applied to it a maximum possible current that still allows intended operation of the energy converter, such that as rapid heating as possible can be achieved by means of the ESR of the intermediate circuit capacitor. Reference is made to the advantages already mentioned above with regard to the energy converter.

Various embodiments provide for the first stage to be regulated to a mean value of the intermediate circuit voltage. This makes it possible to further optimize the operation of the energy converter. In this regard, it can be provided that the control unit has a corresponding changeover mechanism with which the regulation can be set to the voltage mean value.

Furthermore, it can be provided that the intermediate circuit voltage is monitored and the first stage is switched off in the event of a rated voltage of the energy converter being exceeded. The rated voltage is the voltage for which the energy converter is maximally designed during intended operation. The rated voltage is also covered by the standardization, for which reason reference is supplementarily made to the standardization for definition purposes. This makes it possible to provide a protection function that ensures that carrying out the method of the present disclosure does not damage the energy converter. The reliability of the operation of the energy converter can be further improved as a result.

Furthermore, it can be provided that in the event of the intermediate circuit voltage falling below the rated voltage, the first stage is automatically activated again. This feature should be seen in association with the automatic switching off of the energy converter, as discussed above, such that an automatic resumption of intended operation can be realized as soon as the voltage at the intermediate circuit capacitor falls below the rated voltage again. As a result, manual interventions can largely be avoided and the ergonomics of operation can be increased.

It proves to be particularly advantageous if the energy converter, on the input side, uses an AC voltage and is controlled in such a way that an input-side power factor is maximized. As a result, power supply system perturbations can be reduced, in particular in order that limit values imposed by the standardization can be complied with, but also in order to be able to optimize further electrical devices with regard to their operation. In particular, this feature also includes a so-called power factor regulation or power factor control, also called PFC.

One development of the present disclosure proposes that a temperature in the region of the intermediate circuit capacitor is detected. This makes it possible to adapt the method in a temperature dependent manner and to achieve a corresponding control effect. What can furthermore be achieved as a result is that the method of the present disclosure is performed only in the event of a temperature comparison value being undershot. This can improve the ergonomics of the energy converter or else of loads connected thereto.

Therefore, it is furthermore proposed that the detected temperature is compared with a temperature comparison value, and the setting of the power of the second stage is carried out only in the event of the comparison value being undershot.

One development provides for the detection of the temperature to be carried out automatically upon the energy converter being switched on. In this way, as early as upon switch-on it is possible to decide whether carrying out the method according to the present disclosure is expedient or necessary. Finally, according to the present disclosure it can be provided that a second converter in the buck operating mode or a resonant converter is used as the second stage. Reference is made to the advantages and properties of the corresponding converter.

In accordance with various embodiments, the first stage embodied as boost exhibits regulation in such a way that the PFC condition is fulfilled and the mean value of the output voltage is regulated. High output voltages that arise on account of a high ESR of the intermediate circuit capacitor can largely be ignored because they initially have no influence on the mean value. In order to be able to reliably protect components of the converter, an overvoltage shutdown is preferably implemented, which momentarily deactivates the regulation to the PFC at excessively high voltages. As a result, the components of both stages of the energy converter can be reliably protected against an overvoltage. At the same time, it should be taken into consideration that the intermediate circuit capacitor, namely the electrolytic capacitor, is charged less if a shutdown is simply carried out at the voltage maximum. A reduction of the minimum intermediate circuit voltage may thus be the consequence, such that the risk of a shutdown rises. This can be reduced, however, by suitable power regulation of the second stage.

Even though the focus above has been essentially on power with regard to the effect of the present disclosure, the concepts of the present disclosure are equally applicable to a corresponding current regulation and/or current transmission. In particular, it is possible so convert between these variables using the corresponding voltage in a known manner.

In order not to start up with an excessively high power at the very first start, it is expedient to start the energy converter with a power that is as low as possible. One possibility for achieving this is to use an integral controller for the output power or the output current of the energy converter. If the controller is initialized correspondingly low, the power rises from a very small value.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 schematically shows an electronic equivalent circuit diagram for an electrolytic capacitor,

FIG. 2 schematically shows a diagram for the temperature dependence and frequency dependence of the ESR and of the impedance of the electrolytic capacitor in accordance with FIG. 1,

FIG. 3 schematically shows a diagram of a heating curve of selected components of a ballast,

FIG. 4 schematically shows a circuit diagram for a two-stage clocked electronic energy converter such as underlies the present disclosure,

FIG. 5 schematically shows a diagram for a current flow in a first stage of the energy converter in accordance with FIG. 4,

FIG. 6 schematically shows a diagram for a current flow through an electronic switching element of the second stage of the energy converter in accordance with FIG. 4,

FIG. 7 schematically shows a diagram for a current flow in the first stage of the energy converter in accordance with FIG. 4,

FIG. 8 shows a schematic basic circuit diagram for elucidating the peak current in the first stage in accordance with FIG. 4,

FIG. 9 schematically shows a diagram for an intermediate circuit voltage at a two-stage clocked electronic energy converter according to the present disclosure in a normal operating mode,

FIG. 10 schematically shows a diagram like FIG. 9 for high ESR and maximum power,

FIG. 11 schematically shows a diagram like FIG. 9 for high ESR and low power, and

FIG. 12 schematically shows a diagram which illustrates the starting of an energy converter according to the present disclosure.

### DETAILED DESCRIPTION

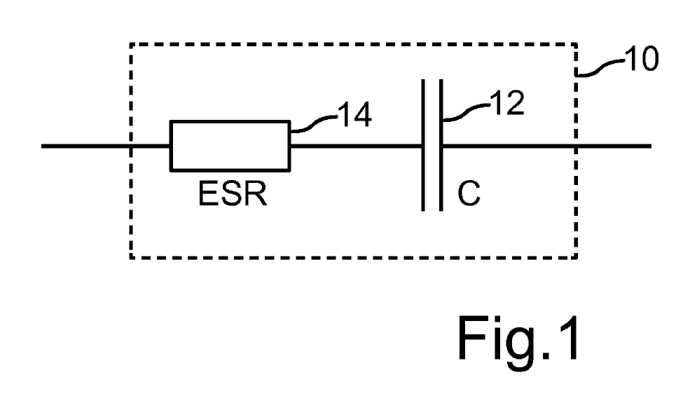

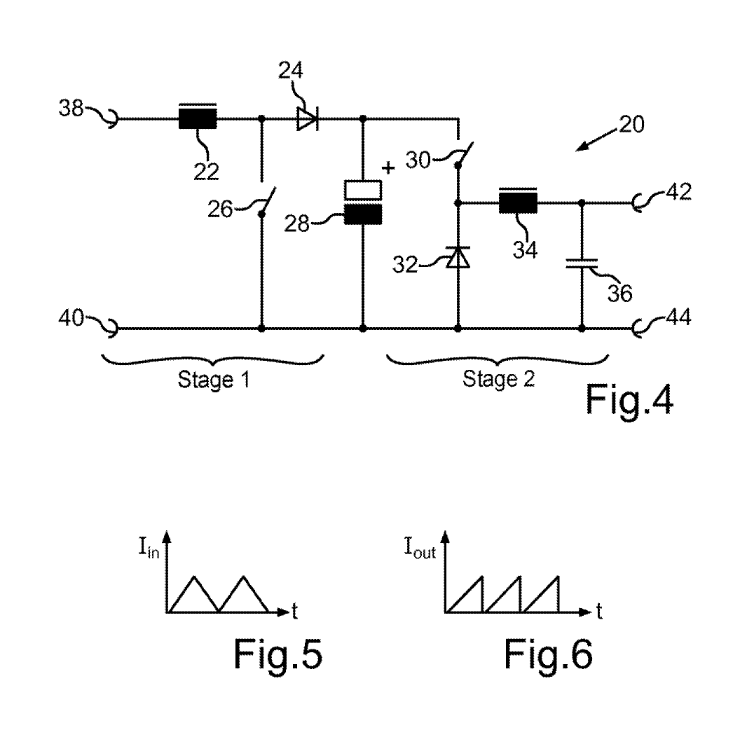

As the lifetime of the electrolytic capacitor increases, the actually usable capacitance of said electrolytic capacitor falls, in principle, whereas the ESR increases its value. In addition, environmental parameters act on the ESR; by way of example, the value of the ESR rises at low temperatures. An equivalent circuit diagram for an electrolytic capacitor is illustrated in FIG. 1. The electrolytic capacitor, which is designated in its entirety by the reference sign 10, has a usable capacitance 12, with which the ESR 14 is connected in series. The equivalent circuit diagram of an electrolytic capacitor as illustrated in FIG. 1 underlies the generic application in the case of the at least two-stage electronic ballast. Such an electrolytic capacitor is used as an intermediate circuit capacitor 28 in the case of a two-stage electronic energy converter 20 in accordance with FIG. 4.

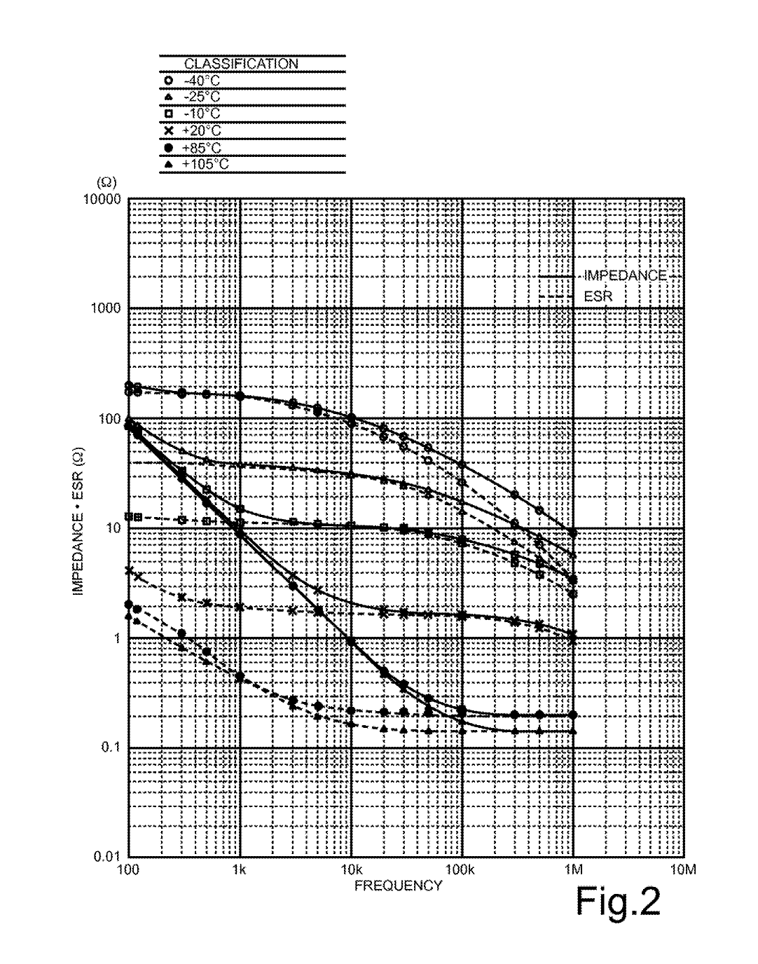

FIG. 2 shows a diagram with measurement logs regarding an impedance and the ESR at various frequencies and temperatures of a typical electrolytic capacitor such as the electrolytic capacitor 10 in accordance with FIG. 1. The frequency in hertz is indicated on a logarithmic scale on the abscissa, whereas the impedance and the ESR in each case in ohms are indicated likewise on a logarithmic scale on the ordinate. A table allowing an assignment of the different curves in the diagram to temperature values of the electrolytic capacitor is illustrated above the diagram.

Overall, it is found that at room temperature, for example at 25° C., and low temperatures, for example −25° C., the ESR of the electrolytic capacitor is significantly higher than at 85° C., generally by a factor in the range of 10 to 20. This likewise holds true, of course, for the intermediate circuit electrolytic capacitor such as is used in the at least two-stage electronic energy converter 20 as ballast. In the case of a window driver, that is to say a driver having a large family of output characteristic curves, in particular with regard to current and voltage, an output current range is 250 mA to approximately 1 A, for example. An output power range of approximately 0.9 W to 90 W is covered in this case. If the electronic ballast is started at maximum power, that is to say at a maximum output power of 90 W, a large voltage swing is the consequence at the intermediate circuit electrolytic capacitor 28, for example +/−80 V. This can have the effect that the light of a luminaire connected to the ballast flickers or the electronic ballast turns off in order to avoid impermissible operating states.

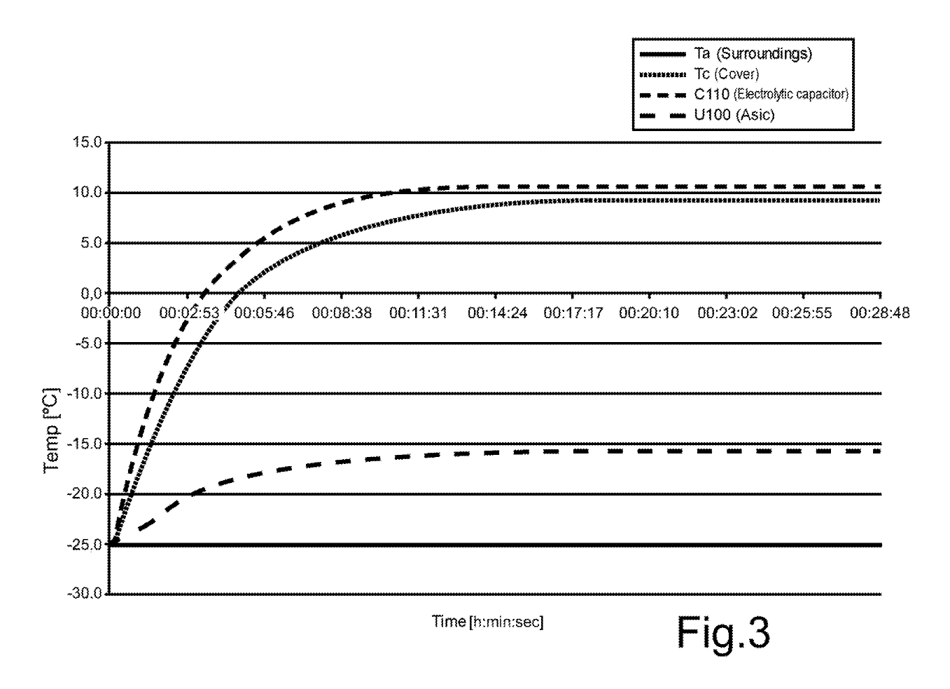

In practice it has been found that, on account of the inherent heating of the ballast, the high ESR at low temperatures generally does not pose a problem for permanent operation. Precisely the ESR itself of the electrolytic capacitor supports fast heating of the electrolytic capacitor and, as a result of this additional inherent heating, ensures that the electrolytic capacitor leaves the range of low temperature and thus attains intended operation following an operating time. Such a heating curve is shown for example in FIG. 3 in a diagram in which time is plotted on the abscissa and temperature in ° C. is plotted on the ordinate. As is evident from FIG. 3, even at a permanently low ambient temperature of −25° C., the electrolytic capacitor reaches a temperature of 0° C. following a specific operating time. During operation in practice, the luminaire temperature and hence the ambient temperature for the ballast will rise further. FIG. 3 thus illustrates the behavior of an actively cooled electronic ballast. Independently of temperature, electrolytic capacitors tend, on account of the high losses in the case of a high ESR, toward heating up at least until the ESR has become low enough that further heating no longer takes place. An equilibrium is thus established. The electrolytic capacitor itself provides for corresponding heating in this way.

In relation to the problem with the ballast at very low temperatures, as explained above, this means that, as a result of the inherent heating of the electrolytic capacitor, the ESR decreases and the voltage swing at the intermediate circuit electrolytic capacitor likewise decreases, with the result that the maximum power desired as intended can be set. Usually, the electronic ballast has, for its intended operation, a computer unit in the form of a microcontroller or the like as control unit, which at the same time also detects an ambient temperature. In this regard, it is possible, before the desired maximum power is actually provided, to reduce the output power to such an extent that operation at reduced power is made possible. As soon as the electrolytic capacitor has heated up to a sufficient extent, the desired maximum output power is automatically set.

One solution to this problem can be achieved by using an electrolytic capacitor having a correspondingly large capacitance and/or a correspondingly large temperature range in the electronic ballast. Furthermore, there is the possibility, of course, of correspondingly restricting the permissible ambient temperature range for the intended operation of the electronic ballast, for example to a range of −15° C. to +50° C. instead of −30° C. to +50° C. Here, too, flicker can occur until the intermediate circuit electrolytic capacitor has heated up to a sufficient extent. A further possibility of bringing about an improvement in terms of circuitry can be achieved by connecting a large film capacitor in parallel with the intermediate circuit electrolytic capacitor. However, these measures are associated with a not inconsiderable portion of costs and with effects on the construction of the electronic ballast, for which reason these measures are used only in extreme situations. The problem will be explained further with reference to FIG. 4, which shows, in a schematic circuit diagram illustration, a two-stage clocked electronic energy converter 20 of the generic type such as is often used in a generic electronic ballast.

FIG. 4 shows a two-stage clocked electronic energy converter 20 that serves for transmitting an electrical power. The energy converter 20 has, as first connection, two connection terminals 38, 40, by means of which the energy converter 20 can be connected to an electrical energy source (not illustrated in further detail) such as a public power supply network or the like. A first stage 1 of the energy converter 20 has an electronic inductance 22, which is connected to the connection terminal 38 by one connection and to an electronic switching element 26, here a switching transistor, by a further connection. In the present case, the switching transistor is embodied as a MOS-FET, the source connection of which is connected to the connection terminal 40. Its drain connection is connected to an anode of a diode 24 besides the electrical connection to the inductance 22. The cathode of the diode 24 is connected to an intermediate circuit capacitor 28, which is in turn likewise connected to the connection terminal 40. The inductance 22, the MOS-FET 26 and the diode 24 form the first stage of the electronic energy converter 20. In the present case, the first stage of the energy converter 20 operates in the boost operating mode, as a result of which an electrical voltage at the first connection is converted into an electrical intermediate circuit voltage at the intermediate circuit capacitor 28 which exceeds the voltage at the first connection.

An electronic switching element 30, in the present case likewise embodied as a MOS-FET, is furthermore connected by its drain connection to the intermediate circuit capacitor 28 as second stage 2 of the energy converter 20. The source connection of the MOS-FET 30 is connected to a cathode of a diode 32 and a further inductance 34. An anode connection of the diode 32 is connected to the connection terminal 40. The inductance 34 is connected by a second connection thereof to a capacitor 36 and also a connection terminal 42 of a second connection for connecting a load. The capacitor 36 is connected by its second connection likewise to the connection terminal 40, to which the connection terminal 44 of the second connection is also connected.

The second stage 2 of the energy converter 20 operates in the buck operating mode in the present case. An electrical voltage provided at the capacitor 36 is thus lower than the intermediate circuit voltage at the intermediate circuit capacitor 28, which is embodied as an electrolytic capacitor in the present case.

FIG. 5 shows the intended operation of the boost converter in the boost operating mode in accordance with the first stage. Time is represented on the abscissa, whereas the current through the inductance 22 is represented on the ordinate. As is evident from FIG. 5, the MOS-FET 26 is switched on for a predefined time period, such that the current through the inductance 22 rises substantially linearly starting at zero up to a maximum value. In the region of the current maximum, the MOS-FET 26 is switched off and the current commutates via the diode 24 into the electrolytic capacitor 28, which forms the intermediate circuit capacitor in the present case. The current flow through the inductance 22 and the diode 24 decreases approximately linearly until the energy in the inductance 22 has dissipated. At this point in time, the current through the inductance 22 is zero and the MOS-FET 26 is switched on again, as a result of which a new cycle follows.

FIG. 6 shows the operation of the buck converter of stage 2, and likewise time is represented on the abscissa and the current through the MOS-FET 30 is represented on the ordinate. It is evident that the MOS-FET 30 is switched on at the coordinate origin, whereupon a current ensues from the intermediate circuit capacitor 28 via the MOS-FET 30 and the inductance 34 into the capacitor 36. The current rises approximately linearly up to a maximum value. When the maximum value is reached, the MOS-FET 30 is switched off and the current through the MOS-FET 30 falls to zero. Via the diode 32, after the MOS-FET 30 has been switched off, the current flow through the inductance 34 can be maintained until the energy stored therein has dissipated.

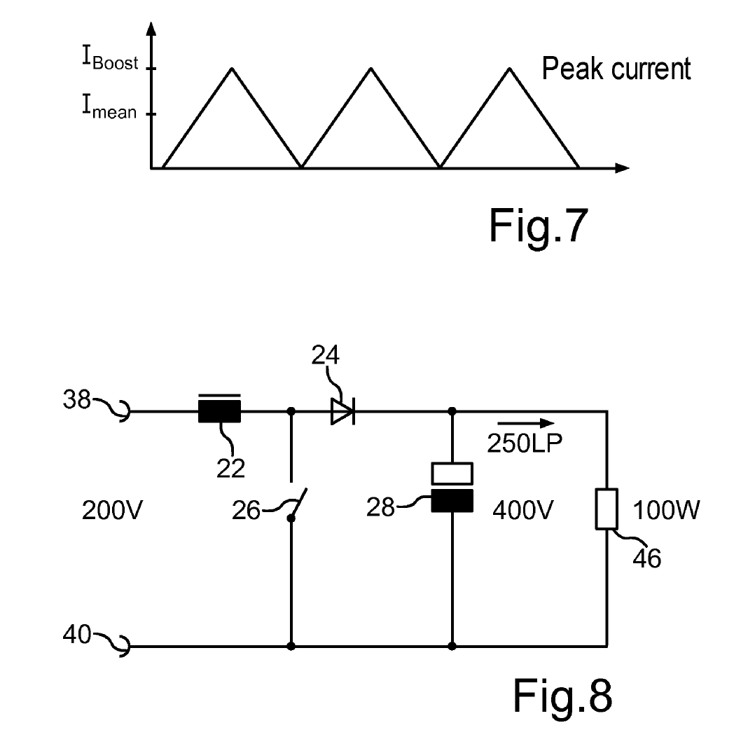

The following effects turn out to be detrimental in the case of this circuit in accordance with FIG. 4:
The first stage generates a positive voltage rise at the intermediate circuit capacitor 28 as a result of the charging current.
The second stage generates a negative voltage as a result of the discharge current for the intermediate circuit capacitor 28, said negative voltage acting in the opposite direction to the positive voltage rise brought about by the first stage.
The two stages of the energy converter 20 are generally not synchronized, with the result that the two effects mentioned above greatly increase a voltage amplitude of the intermediate circuit voltage at the intermediate circuit capacitor 28.
The intermediate circuit capacitor, embodied as an electrolytic capacitor, has an ESR that is indeed significantly lower for high frequencies than at 100 Hz, but in return the peak currents of the energy converter 20 are significantly higher than the mean current.
An example in which the high-frequency peak current is greater by a factor of 4 is shown with reference to FIGS. 7 and 8.

FIG. 8 shows a basic equivalent circuit diagram for an electronic energy converter such as has already been described with reference to FIG. 4 with regard to stage 1. In contrast to FIG. 4, instead of the second stage 2, an electrical load in the form of an electrical resistor 46 is connected to the intermediate circuit capacitor 28. Further parameters are indicated in FIG. 4, namely an input voltage of 200 V at the connection terminals 38, 40, an intermediate circuit voltage at the intermediate circuit capacitor 28 of 400 V and a power of the load 46 of 100 W. From the values indicated, a mean current results as 100 W/200 V=0.5 A. Moreover, a peak current correspondingly results as 1 A. This is illustrated in the diagram in FIG. 7, which shows time on the abscissa and the current through the inductance 22, here I_{Boost}, on the ordinate. It is evident from FIG. 7 that the mean current, designated here as Iₘₑₐₙ, is half the magnitude of the peak current illustrated in FIG. 7.

To summarize, it can thus be established that the intermediate circuit capacitor 28 arranged between two high-frequency converter stages, namely stage 1 and stage 2, has the effect that during AC voltage operation the ripple voltages at the intermediate circuit capacitor 28 on account of the 100 Hz ripple are superposed with the voltages on account of the high-frequency ripple. Although the ESR is lower in the case of high-frequency currents, in return the high-frequency peak currents are higher.

The following points should therefore be taken into consideration when the energy converter 20 is started:
Excessively high voltages must not occur at the intermediate circuit capacitor 28. These voltages can jeopardize not only the electrolytic capacitor but primarily also the electronic components involved, in particular the semiconductor components of the energy converter 20, for example MOS-FETs, diodes and/or the like.
By contrast, very low voltages at the intermediate circuit capacitor 28 can result in the entire device being switched off. This occurs on account of safety circuits in order to avoid flicker during the operation of luminaries and/or to protect a connected illuminant.
Repeated switching on and off should preferably not take place because the flicker or flashing of light is perceived, as very disturbing.

This behavior is a major reason why generic ballasts are not approved for very low temperatures, for example less than −20° C. In the prior art, therefore, testing usually only involves ascertaining up to what ESR the device still starts reliably or, alternatively, a sufficiently good and expensive electrolytic capacitor is used as the intermediate circuit capacitor. Any change to the energy converter 20 or else the qualification of new electrolytic capacitors as intermediate circuit capacitors takes up a great deal of time and is expensive.

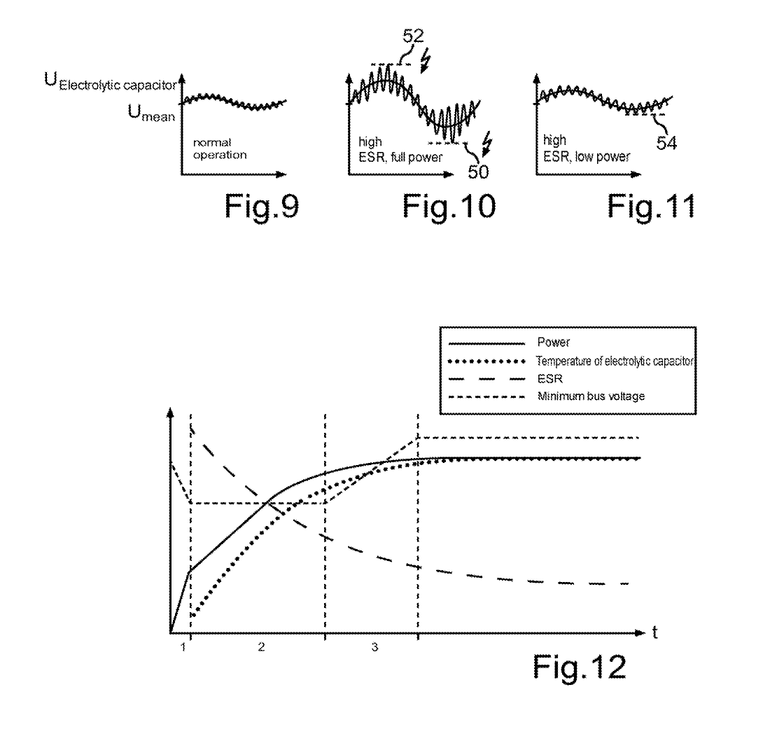

FIG. 9 shows, in a schematic diagram illustration, a graph for the intermediate circuit voltage at the intermediate circuit capacitor in a normal operating mode, wherein the abscissa represents a time axis, and the ordinate represents the intermediate circuit voltage. FIG. 9 shows the normal operating mode with an intermediate circuit voltage which fluctuates with the rhythm of an AC voltage present at the first connection of the energy converter 20. It is evident that a ripple voltage is superposed which arises on account of the operation of the two stages of the energy converter 20.

FIG. 10 schematically shows a diagram like FIG. 9, wherein here the intermediate circuit capacitor 28, which is an electrolytic capacitor, has a high ESR. At the same time, by means of the second stage of the energy converter 20, the maximum power is drawn from the intermediate circuit capacitor 28. It is evident that the amplitude is considerably increased both with regard to the power supply system frequency and with regard to the ripple.

FIGS. 9 to 10 show operating states of the energy converter 20 in accordance with FIG. 4 during corresponding operation, wherein a power supply system AC voltage as supply voltage is connected to the first connection. It is evident that, according to the present disclosure, the drawing of power is regulated by the second stage in such a way that a predefined voltage comparison value is not undershot, that is to say that an instantaneous minimum of the intermediate circuit voltage is greater than the predefined voltage comparison value. The voltage comparison value is identified here by the reference sign 50. At the same time, the power of the second stage is set in such a way that the maximum intermediate circuit voltage 52 is not exceeded. The latter is defined on the basis of the rated voltage of the energy converter 20.

It is evident from FIG. 10 that the ESR of the intermediate circuit capacitor 28 is used to heat the intermediate circuit capacitor 28. This is expedient particularly with regard to the property illustrated by FIG. 3, namely that the intermediate circuit capacitor heats up rapidly on account of the high ESR and this simultaneously leads to a reduction of the ESR until an equilibrium state is set.

FIG. 11 shows an illustration of the use of the high ESR of the intermediate circuit capacitor 28 at a low power that is drawn by the second stage of the energy converter 20. A voltage comparison value 54 is predefined in a correspondingly increased manner, such that as rapid heating as possible of the electrolytic capacitor can be achieved here as well.

FIG. 12 shows, in a schematic diagram illustration, starting of a two-stage clocked electronic energy converter such as the energy converter 20 from FIG. 4 using the method of the present disclosure. Once again time is plotted on the abscissa, whereas the corresponding values of the parameters indicated in the diagram are indicated on the ordinate. It is evident that the power rises linearly from zero up to the point in time 1 and then rises further in accordance with a curve up to the desired value of the power. It is furthermore evident that during the power rise the value of the ESR of the intermediate circuit capacitor 28 is reduced asymptotically to a value in intended operation. Correspondingly, the temperature of the intermediate circuit capacitor 28 increases up to a temperature at which an equilibrium is established.

It is furthermore evident that a voltage comparison value, referred to here as minimum BUS voltage, is adapted according to the different operating states. The minimum bus voltage in FIG. 12 is the really measured minimum within half a power supply system period (10 ms). Said minimum arises according to the present disclosure because a lower limit is defined, represented by the lower plateau within the profile of the really measured minimum. Said limit is always fixed. In a first section 1, in which the power rises linearly from 0, the minimum BUS voltage is correspondingly reduced linearly to a predefined value. In a second time period 2, the minimum BUS voltage is kept constant until it rises linearly again in a subsequent time period 3, so as then to be kept constant after the time period 3 at the value reached there.

The embodiment serves only for explaining the present disclosure and is not restrictive for the present disclosure.

In this regard, of course, functions, in particular electronic components and the energy converter, can be fashioned as desired, without departing from the concept of the present disclosure.

The advantages and features and also embodiments described for the method according to the present disclosure equally apply to the energy converter according to the present disclosure, and vice versa. Consequently, corresponding device features can be provided for method features, and vice versa.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A two-stage clocked electronic energy converter for transmitting an electrical power, comprising a first connection for connecting an electrical energy source, a second connection for connecting a load, and an intermediate circuit capacitor, wherein a first stage of the two-stage clocked electronic energy converter has a first converter in the boost operating mode, which first converter converts an electrical voltage at the first connection into an electrical intermediate circuit voltage at the intermediate circuit capacitor, and wherein the intermediate circuit capacitor supplies a second stage of the two-stage clocked electronic energy converter, which second stage supplies the load with electrical energy controllably in terms of the power, wherein a control unit is configured to set the power drawn from the intermediate circuit capacitor by the second stage in such a way that an instantaneous minimum of the intermediate circuit voltage that is brought about by the drawing of power is greater than a predefined voltage comparison value.

2. The energy converter as claimed in claim 1, wherein the voltage comparison value is formed taking account of an instantaneous voltage comparison value determined depending on a temporally corresponding instantaneous value of the electrical voltage at the first connection, and the drawing of power is set in such a way that the instantaneous minimum of the intermediate circuit voltage substantially reaches the instantaneous voltage comparison value.

3. The energy converter as claimed in claim 1, wherein the second stage of the two-stage clocked electronic energy converter has a second converter in the buck operating mode or a resonant converter.

4. The energy converter as claimed in claim 1, wherein the intermediate circuit capacitor has a temperature sensor.

5. A lighting device comprising an illuminant, an electrical connection for connecting the lighting device to an electrical energy source, and a two-stage clocked electronic energy converter, which supplies, as load, the illuminant with electrical energy controllably in terms of the power, the energy converter comprising a first connection for connecting an electrical energy source, a second connection for connecting a load, and an intermediate circuit capacitor, wherein a first stage of the two-stage clocked electronic energy converter has a first converter in the boost operating mode, which first converter converts an electrical voltage at the first connection into an electrical intermediate circuit voltage at the intermediate circuit capacitor, and wherein the intermediate circuit capacitor supplies a second stage of the two-stage clocked electronic energy converter, which second stage supplies the load with electrical energy controllably in terms of the power, wherein a control unit is configured to set the power drawn from the intermediate circuit capacitor by the second stage in such a way that an instantaneous minimum of the intermediate circuit voltage that is brought about by the drawing of power is greater than a predefined voltage comparison value.

6. A method for operating a two-stage clocked electronic energy converter, having an intermediate circuit capacitor, for transmitting an electrical power from an electrical energy source, connected to the energy converter, to a load, likewise connected to the energy converter, wherein a first stage of the two-stage clocked electronic energy converter uses a first converter in the boost operating mode, which first converter converts an input-side electrical voltage of the electrical energy source into an electrical intermediate circuit voltage at the intermediate circuit capacitor, which intermediate circuit capacitor supplies a second stage of the two-stage clocked electronic energy converter with electrical energy, which second stage supplies the load with electrical energy controllably in terms of the power, wherein the power drawn from the intermediate circuit capacitor by the second stage is set in such a way that an instantaneous minimum of the intermediate circuit voltage that is brought about by the drawing of the power exceeds a predefined voltage comparison value.

7. The method as claimed in claim 6, wherein an instantaneous voltage comparison value determined depending on a temporally corresponding instantaneous value of the electrical voltage at the first connection is used as the voltage comparison value, and the instantaneous minimum of the intermediate circuit voltage substantially reaches the instantaneous voltage comparison value.

8. The method as claimed in claim 6, wherein the first stage is regulated to a mean value of the intermediate circuit voltage.

9. The method as claimed in claim 6, wherein the intermediate circuit voltage is monitored and the first stage is switched off in the event of a rated voltage of the energy converter being exceeded.

10. The method as claimed in claim 9, wherein, in the event of the intermediate circuit voltage falling below the rated voltage, the first stage is automatically activated again.

11. The method as claimed in claim 6, wherein the energy converter, on the input side, uses an AC voltage and is controlled in such a way that an input-side power factor is maximized.

12. The method as claimed in claim 6, wherein a temperature in the region of the intermediate circuit capacitor is detected.

13. The method as claimed in claim 12, wherein the detected temperature is compared with a temperature comparison value, and the setting of the power of the second stage is carried out only in the event of the comparison value being undershot.

14. The method as claimed in claim 12, wherein the detection of the temperature is carried out automatically upon the energy converter being switched on.

15. The method as claimed in claim 6, wherein a second converter in the buck operating mode or a resonant converter is used as the second stage.
